(19) United States
(12) Patent Application Publication
(10) Pub. No.: US 2014/0112271 A1
(43) Pub. Date: Apr. 24, 2014

(54) METHOD AND APPARATUS TO IMPLEMENT DISCONTINUOUS RECEPTION (DRX) IN A WIRELESS COMMUNICATION SYSTEM

(71) Applicant: INNOVATIVE SONIC CORPORATION, Taipei City (TW)

(72) Inventor: Li-Te Pan, Taipei City (TW)

(73) Assignee: INNOVATIVE SONIC CORPORATION, Taipei City (TW)

(21) Appl. No.: 14/058,675

(22) Filed: Oct. 21, 2013

Related U.S. Application Data
(60) Provisional application No. 61/716,747, filed on Oct. 22, 2012.

(51) Int. Cl. H04W 76/04

(52) U.S. Cl. CPC H04W 76/048
USPC 370/329

(57) ABSTRACT

A method and apparatus are disclosed to implement DRX (Discontinuous Reception) in a UE (User Equipment). The method includes configuring the UE with at least a small cell, and serving the UE with a macro cell, wherein the macro cell is controlled by a MeNB (Master evolved Node B) and the small cell is controlled by a SeNB (Secondary evolved Node B). In addition, the method includes configuring DRX with a plurality of drxStartOffset parameters, wherein at least one of the drxStartOffset parameters is used for the MeNB and at least one of the drxStartOffset parameters is used for the SeNB. Furthermore, the method includes starting the UE on an onDurationTimer when a drxStartOffset condition is satisfied.

### CROSS-REFERENCE TO RELATED APPLICATIONS

The present application claims the benefit of U.S. Provisional Patent Application Ser. No. 61/716,747 filed on Oct. 22, 2012, the entire disclosure of which is incorporated herein by reference.

### FIELD

This disclosure generally relates to wireless communication networks, and more particularly, to a method and apparatus to implement DRX in a UE in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to implement DRX (Discontinuous Reception) in a UE (User Equipment). The method includes configuring the UE with a small cell, and serving the UE with a macro cell, wherein the macro cell is controlled by a MeNB (Master evolved Node B) and the small cell is controlled by a SeNB (Secondary evolved Node B). In addition, the method includes configuring DRX with a plurality of drxStartOffset parameters, wherein at least one of the drxStartOffset parameters is used for the MeNB and at least one of the drxStartOffset parameters is used for the SeNB. Furthermore, the method includes starting the UE on an onDurationTimer when a drxStartOffset condition is satisfied.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow chart according to one exemplary embodiment.

FIG. 6 is a diagram according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. RWS-120052, “Summary of TSG-RAN Workshop on Release 12 and Onwards”; RWS-120002, “Release 12 for C⁴ (Cost, Coverage, Coordination with small cells and Capacity)”; TR 36.932 v0.1.0, “Scenarios and Requirements for Small Cell Enhancement”; TS 36.321 v11.0.0, “Medium Access Control (MAC) protocol specification”; and TS 36.331 v11.1.0, “Radio Resource Control (RRC) protocol specification.” The standards and documents listed above are hereby expressly incorporated herein.

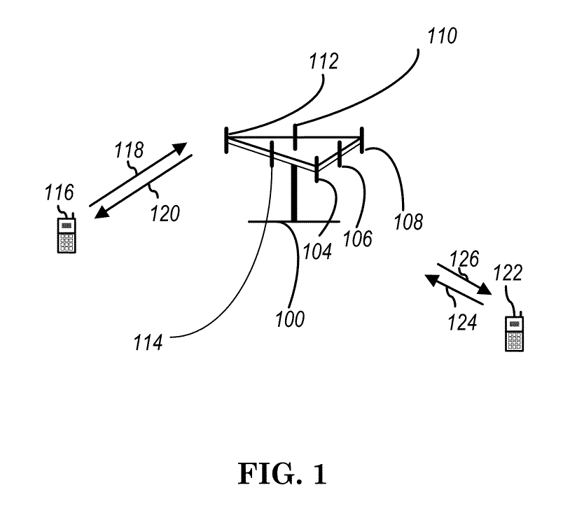

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

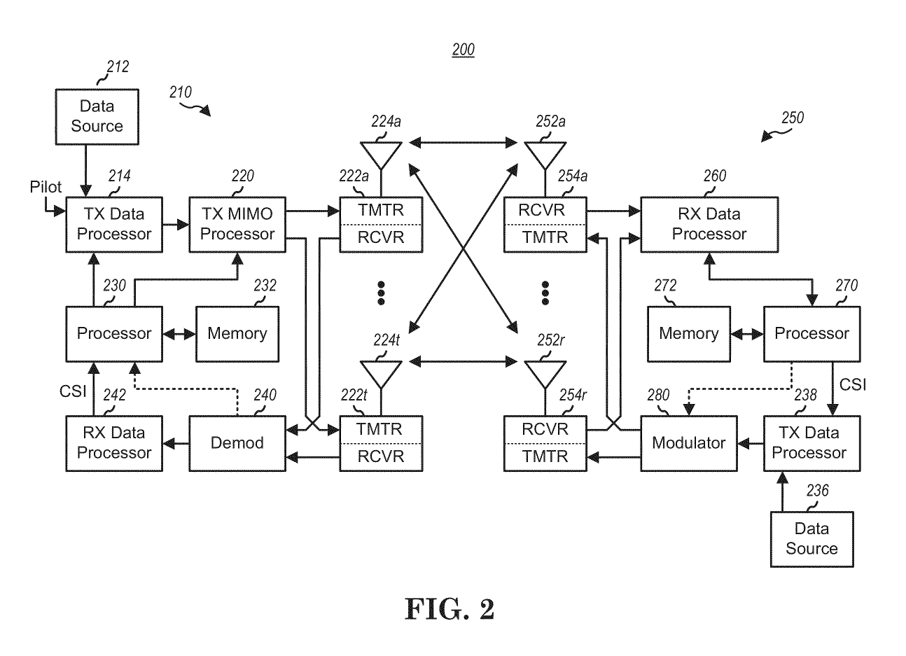

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

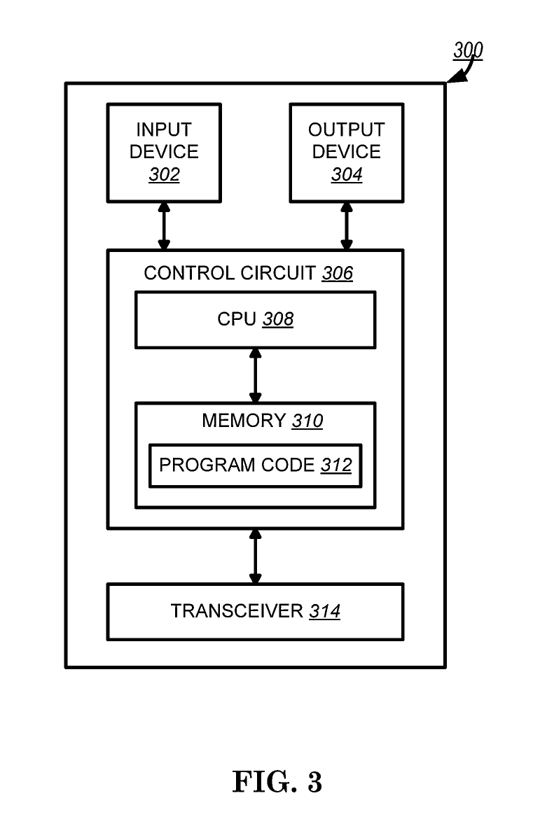

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

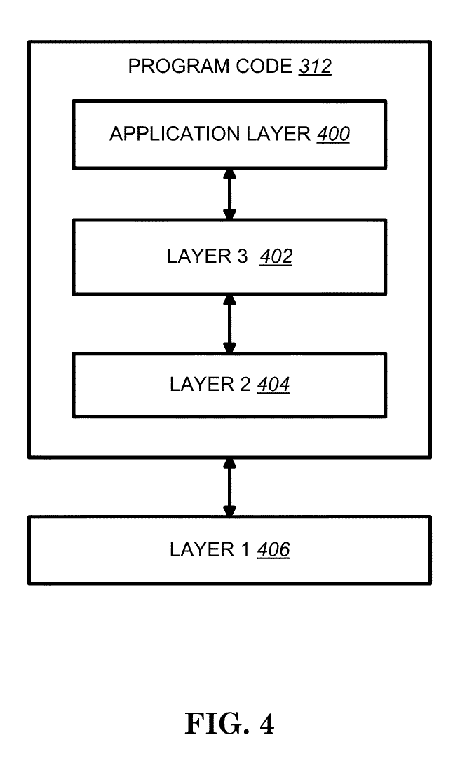

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP RAN Workshop Report RWS-120052 discusses and considers a potential small cell enhancement to cope with the explosion of mobile traffic. In order to boost the capacity of already deployed cellular network, the enhancement targets the deployment scenario in which small cell nodes are deployed under the coverage of one or more than one overlaid E-UTRAN macro-cell layer(s). In such deployment scenario, the small cell could be used for inter-site CA (Carrier Aggregation) operation as discussed in 3GPP RWS-120002.

In the initial email discussion for the “Study on Scenarios and Requirements for LTE Small Cell Enhancements”, issues and requirements regarding the interface between macro cell node (MeNB—“Master eNB”) and small cell node (SeNB—“Secondary eNB”) were raised and discussed. In general, it was agreed and accepted that the current X2 interface as the baseline so that the SeNBs and MeNBs could exchange information about each other the information via the applicable X2 interface. Based on 3GPP TS 36.420 v11.0.0, the X2 interface, in general, provides a mechanism to allow interconnected eNBs to coordinate, negotiate, and/or transfer information and/or data. The initial email discussion for the “Study on Scenarios and Requirements for LTE Small Cell Enhancements” provides the following description and discussion about the applicable X2 interface:

[1b.] Whether X2 interface could be assumed between macro and small cell, as well as between small cell and small cell?
Proposed way forward:
The studies should first identify which kind of information is needed or beneficial to be exchanged between nodes in order to get the desired improvements before the actual type of interface is determined. And if direct interface should be assumed between macro and small cell, as well as between small cell and small cell, X2 interface can be used as a starting point.

Furthermore, 3GPP TS 36.321 v11.0.0 specifies the discontinuous reception (DRX) functionality and the related drxStartOffset condition as follows:

### 5.7 Discontinuous Reception (DRX)

The UE may be configured by RRC with a DRX functionality that controls the UE's PDCCH
monitoring activity for the UE's C-RNTI, TPC-PUCCH-RNTI, TPC-PUSCH-RNTI and Semi-Persistent
Scheduling C-RNTI (if configured). When in RRC_CONNECTED, if DRX is configured, the UE is
allowed to monitor the PDCCH discontinuously using the DRX operation specified in this
subclause; otherwise the UE monitors the PDCCH continuously. When using DRX operation, the
UE shall also monitor PDCCH according to requirements found in other subclauses of this
specification. RRC controls DRX operation by configuring the timers onDurationTimer, drx-
InactivityTimer, drx-RetransmissionTimer (one per DL HARQ process except for the broadcast
process), the longDRX-Cycle, the value of the drxStartOffset and optionally the
drxShortCycleTimer and shortDRX-Cycle. A HARQ RTT timer per DL HARQ process (except for
the broadcast process) is also defined (see subclause 7.7).
When a DRX cycle is configured, the Active Time includes the time while:
- onDurationTimer or drx-InactivityTimer or drx-RetransmissionTimer or mac-
ContentionResolutionTimer (as described in subclause 5.1.5) is running; or
- a Scheduling Request is sent on PUCCH and is pending (as described in subclause 5.4.4); or
- an uplink grant for a pending HARQ retransmission can occur and there is data in the
corresponding HARQ buffer; or
- a PDCCH indicating a new transmission addressed to the C-RNTI of the UE has not been
received after successful reception of a Random Access Response for the preamble not
selected by the UE (as described in subclause 5.1.4).
When DRX is configured, the UE shall for each subframe:
. . .
- If the Short DRX Cycle is used and [(SFN * 10) + subframe number] modulo (shortDRX-Cycle) =
(drxStartOffset) modulo (shortDRX-Cycle); or
- if the Long DRX Cycle is used and [(SFN * 10) + subframe number] modulo (longDRX-Cycle) =
drxStartOffset:
- start onDurationTimer.
- during the Active Time, for a PDCCH-subframe, if the subframe is not required for uplink
transmission for half-duplex FDD UE operation and if the subframe is not part of a
configured measurement gap:
- monitor the PDCCH;
. . .

In addition, the configuration of discontinuous reception (DRX) is specified in 3GPP TS 36.331 v11.1 as follows:

MAC-MainConfig

The IE MAC-MainConfig is used to specify the MAC main configuration for signalling and data radio bearers.

MAC-MainConfig information element

-- ASN1START

| | |
|---|---|
| MAC-MainConfig ::= | SEQUENCE { |

| [...] | | |
|---|---|---|
| drx-Config | DRX-Config | OPTIONAL, -- Cond DRX-r8 |

[...]

}
[...]

| | |
|---|---|
| DRX-Config ::= | CHOICE { |

| | |
|---|---|
| release | NULL, |
| setup | SEQUENCE { |

| | |
|---|---|
| onDurationTimer | ENUMERATED { |

psf1, psf2, psf3, psf4, psf5, psf6,
psf8, psf10, psf20, psf30, psf40,
psf50, psf60, psf60, psf100,
psf200},

| [...] | |
|---|---|
| longDRX-CycleStartOffset | CHOICE { |

| | |
|---|---|
| sf10 | INTEGER(0..9), |
| sf20 | INTEGER(0..19), |
| sf32 | INTEGER(0..31), |
| sf40 | INTEGER(0..39), |
| sf64 | INTEGER(0..63), |
| sf80 | INTEGER(0..79), |
| sf128 | INTEGER(0..127), |
| sf160 | INTEGER(0..159), |
| sf256 | INTEGER(0..255), |
| sf320 | INTEGER(0..319), |
| sf512 | INTEGER(0..511), |
| sf640 | INTEGER(0..639), |
| sf1024 | INTEGER(0..1023), |
| sf1280 | INTEGER(0..1279), |
| sf2048 | INTEGER(0..2047), |
| sf2560 | INTEGER(0..2559) |

},
[...]

}

}
[...]

}

}
[...]
-- ASN1STOP

MAC-MainConfig field descriptions

[. . .]
longDRX-CycleStartOffset
longDRX-Cycle and drxStartOffset in TS 36.321 [6]. The value of longDRX-Cycle is in number of
sub-frames. Value sf10 corresponds to 10 sub-frames, sf20 corresponds to 20 sub-frames and so
on. If shortDRX-Cycle is configured, the value of longDRX-Cycle shall be a multiple of the
shortDRX-Cycle value. The value of drxStartOffset value is in number of sub-frames.
[. . .]
onDurationTimer
Timer for DRX in TS 36.321 [6]. Value in number of PDCCH sub-frames. Value psf1 corresponds
to 1 PDCCH sub-frame, psf2 corresponds to 2 PDCCH sub-frames and so on.
[. . .]

In Rel.10 for intra-site CA, the DRX-configured UE could monitor PDCCH (Physical Downlink Control Channel) subframes on the serving cells on the specific OnDuration using one set of DRX timers because these serving cells are configured to the DRX-configured UE and are scheduled by the same eNB. But for the inter-site CA in the future, because the traffic conditions may be different for each eNB (for example, traffic bursts in each eNB may occur at different places), the configuration of a function (such as OnDuration in DRX) by each eNB may be different to a UE. Thus, the configuration of the corresponding onDuration by a MeNB and SeNB to a UE should be re-evaluated and considered.

In one embodiment, it is assumed that the SeNB(s) would be deployed under the coverage of the macro cell, and would cooperate with a MeNB and support the inter-site CA operation. In general, a method of implement DRX with different drxStartOffset values is proposed to allow a UE to monitor PDCCH-subframes for both macro cell and small cell in an inter-site CA operation. The general concept is that a UE served by both the macro cell and the small cell would be configured with DRX and inter-site CA. If the SeNB would like to configure the DRX but the position of OnDuration is different from MeNB, the MeNB could configure an additional drxStartOffset to the UE. Thus, the UE could monitor the PDCCH-subframes on both macro cell and small cell on separate OnDurations using one set of DRX timers.

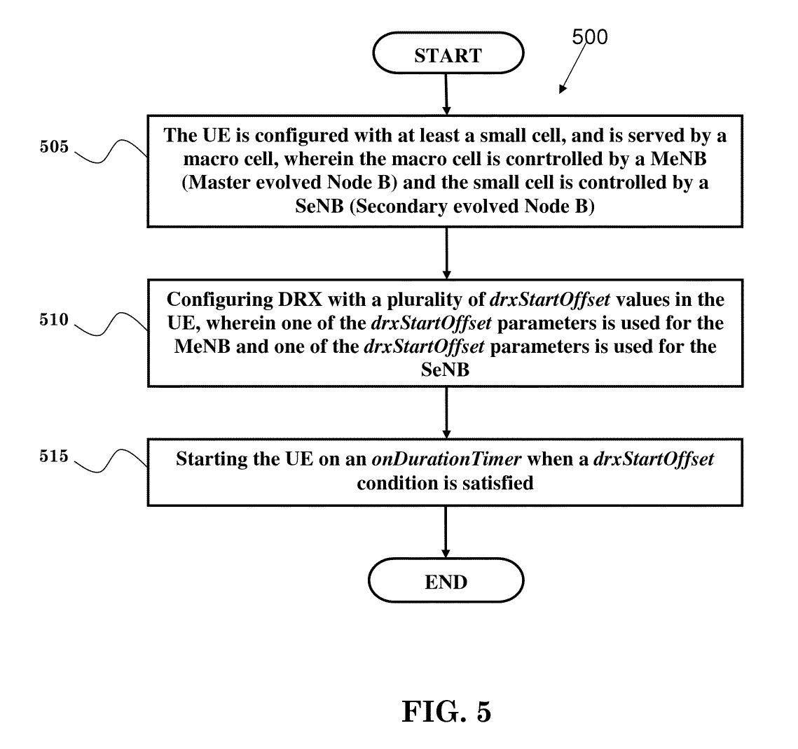

FIG. 5 is a flow chart 500 in accordance with one exemplary embodiment. In step 505, the UE is configured with at least a small cell, and is served by a macro cell, wherein the macro cell is controlled by a MeNB and the small cell is controlled by a SeNB. Step 510 includes configuring DRX with a plurality of drxStartOffset values in the UE, such that at least one of the drxStartOffset parameters is used for the MeNB and at least one of the drxStartOffset parameters is used for the SeNB.

In Step 515, the UE is started on an onDurationTimer when a drxStartOffset condition is satisfied. As discussed above, Section 5.7 of 3GPP TS36.321 v11.0.0 provides the following description or formulation for determining when a drxStartOffset condition is satisfied:

### 5.7 Discontinuous Reception (DRX)

. . .
When DRX is configured, the UE shall for each subframe:
. . .
- If the Short DRX Cycle is used and [(SFN * 10) + subframe number]
modulo (shortDRX-Cycle) = (drxStartOffset) modulo (shortDRX-Cycle);
or
- if the Long DRX Cycle is used and [(SFN * 10) + subframe number]
modulo (longDRX-Cycle) = drxStartOffset:
- start onDurationTimer.
. . .

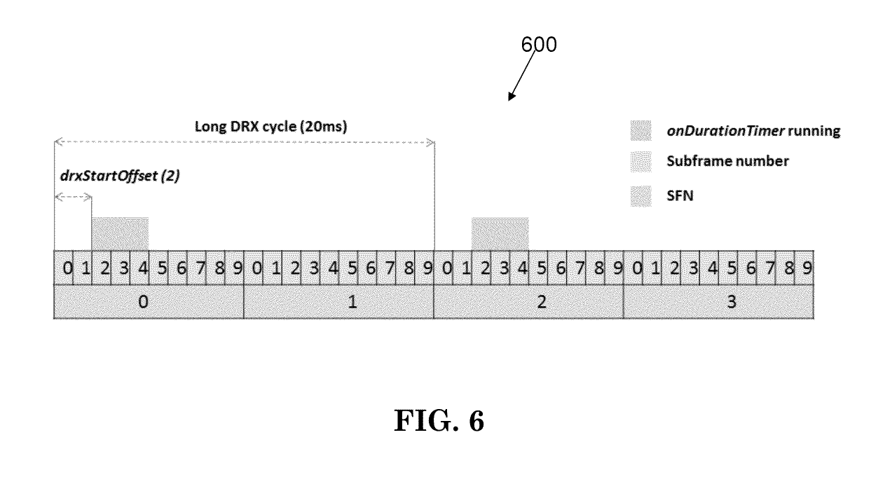

In general, a drxStartOffset condition would be satisfied when the above formulation or equation is fulfilled. As an example, the long DRX cycle occurs periodically (for instance, every 20 ms DRX cycle) repeats at a specific start timing (for example, drxStartOffset is 2. As illustrated in diagram 600 of FIG. 6, the above formulation or equation (i.e., (SFN 0*10)+subframe number 2] modulo longDRX-Cycle 20=drxStartOffset 2) would be fulfilled at the timing of SFN=0/subframe=2 and the timing of SFN=2/subframe2. When the equation is fulfilled, the drxStartOffset condition would be satisfied, and the onDurationTimer would start.

In one embodiment, the drxStartOffset parameter for the SeNB could be configured to the UE via a RRC (Radio Resource Control) message by the MeNB, a RRC (Radio Resource Control) message by the SeNB, or a MAC (Medium Access Control) control element message by the SeNB. Alternatively, the drxStartOffset parameter used for the SeNB and the drxStartOffset parameter used for the MeNB could be simultaneously configured to the UE via a RRC message by the MeNB. Furthermore, the SeNB and the MeNB would exchange necessary information about radio resource allocation to decide an appropriate drxStartOffset parameter. In addition, the SeNB could be controlled by one MeNB or by multiple MeNBs simultaneously. Alternatively, the SeNB could be independent from the MeNB, and cooperates with the MeNB.

In one embodiment, the UE could be served by a plurality of small cells, and each small cell or each group of small cells is controlled by the same SeNB. In addition, the onDurationTimer would be restarted if a drxStartOffset condition is satisfied during the onDurationTimer in operation. Furthermore, the UE would monitor PDCCH-subframes on macro cell during the onDurationTimer in operation if the drxStartOffset is used for the MeNB and the corresponding drxStartOffset condition is satisfied. Alternatively, the UE monitors PDCCH-subframes on small cell during the onDurationTimer in operation if the drxStartOffset is used for the SeNB and the corresponding drxStartOffset condition is satisfied.

Referring back to FIGS. 3 and 4, in one embodiment, the device 300 includes a program code 312 stored in memory 310. In one embodiment, the CPU 308 could execute the program code 312 (i) to configure the UE with a small cell, and serve the UE with a macro cell, wherein the macro cell is controlled by a MeNB and the small cell is controlled by a SeNB, (ii) to configure DRX with a plurality of drxStartOffset parameters, wherein at least one of the drxStartOffset parameters is used for the MeNB and at least one of the drxStartOffset parameters is used for the SeNB, and (iii) to start the UE on an onDurationTimer when a drxStartOffset condition is satisfied. In addition, the CPU 308 could execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method to implement DRX (Discontinuous Reception) in a UE (User Equipment), comprising:
configuring the UE with at least a small cell, and serving the UE with a macro cell, wherein the macro cell is controlled by a MeNB (Master evolved Node B) and the small cell is controlled by a SeNB (Secondary evolved Node B);
configuring DRX with a plurality of drxStartOffset parameters, wherein at least one of the drxStartOffset parameters is used for the MeNB and at least one of the drxStartOffset parameters is used for the SeNB; and
starting the UE on an onDurationTimer when a drxStartOffset condition is satisfied.

2. The method of claim 1, wherein the drxStartOffset parameter used for the SeNB is configured to the UE via any RRC (Radio Resource Control) message by the MeNB, a RRC (Radio Resource Control) message by the SeNB, or a MAC (Medium Access Control) control element message by the SeNB.

3. The method of claim 1, wherein the drxStartOffset parameter used for the SeNB and the drxStartOffset parameter used for the MeNB are simultaneously configured to the UE via a RRC message by the MeNB.

4. The method of claim 1, wherein the UE is served by a plurality of small cells, and each small cell or each group of small cells is controlled by the same SeNB.

5. The method of claim 1, wherein the onDurationTimer is restarted if a drxStartOffset condition is satisfied during the onDurationTimer in operation.

6. The method of claim 1, wherein the SeNB and the MeNB exchange necessary information to decide an appropriate drxStartOffset parameter, wherein the information including radio resource allocation.

7. The method of claim 1, wherein the UE monitors PDCCH-subframes on macro cell during the onDurationTimer in operation if the drxStartOffset is used for the MeNB and the corresponding drxStartOffset condition is satisfied.

8. The method of claim 1, wherein the UE monitors PDCCH-subframes on small cell during the onDurationTimer in operation if the drxStartOffset is used for the SeNB and the corresponding drxStartOffset condition is satisfied.

9. A UE (User Equipment) for implementing DRX (Discontinuous Reception) in a wireless communications system, the UE comprising:
a control circuit;
a processor installed in the control circuit;
a memory installed in the control circuit and operatively coupled to the processor;
wherein the processor is configured to execute a program code stored in the memory to:
configure the UE with at least a small cell, and serve the UE with a macro cell, wherein the macro cell is controlled by a MeNB (Master evolved Node B) and the small cell is controlled by a SeNB (Secondary evolved Node B);
configure DRX with a plurality of drxStartOffset parameters, wherein at least one of the drxStartOffset parameters is used for the MeNB and at least one of the drxStartOffset parameters is used for the SeNB; and
start the UE on an onDurationTimer when a drxStartOffset condition is satisfied.

10. The UE of claim 9, wherein the drxStartOffset parameter for the SeNB is configured to the UE via any RRC (Radio Resource Control) message by the MeNB, a RRC (Radio Resource Control) message by the SeNB, or a MAC (Medium Access Control) control element message by the SeNB.

11. The UE of claim 9, wherein the drxStartOffset parameter used for the SeNB and the drxStartOffset parameter used for the MeNB are simultaneously configured to the UE via a RRC message by the MeNB.

12. The UE of claim 9, wherein the UE is served by a plurality of small cells, and each small cell or each group of small cells is controlled by the same SeNB.

13. The UE of claim 9, wherein the onDurationTimer is restarted if a drxStartOffset condition is satisfied during the onDurationTimer in operation.

14. The UE of claim 9, wherein the SeNB and the MeNB exchange necessary information to decide an appropriate drxStartOffset parameter, wherein the information including radio resource allocation.

15. The UE of claim 9, wherein the UE monitors PDCCH-subframes on macro cell during the onDurationTimer in operation if the drxStartOffset is used for the MeNB and the corresponding drxStartOffset condition is satisfied.

16. The UE of claim 9, wherein the UE monitors PDCCH-subframes on small cell during the onDurationTimer in operation if the drxStartOffset is used for the SeNB and the corresponding drxStartOffset condition is satisfied.
